(19) United States
(12) Patent Application Publication
(10) Pub. No.: US 2026/0330951 A1
(43) Pub. Date: Oct. 22, 2026

(54) INFORMATION PROCESSING DEVICE, INFORMATION PROCESSING METHOD, AND PROGRAM

(71) Applicant: NS SOLUTIONS CORPORATION, Minato-ku, Tokyo (JP)

(72) Inventors: Chizuru MORI, Minato-ku, Tokyo (JP); Kazuyoshi MORIYA, Minato-ku, Tokyo (JP); Shinya FUJIMOTO, Minato-ku, Tokyo (JP); Minori KAWASAKI, Minato-ku, Tokyo (JP)

(21) Appl. No.: 19/104,928

(22) PCT Filed: Jul. 13, 2023
(86) PCT No.: PCT/JP2023/025834

§ 371 Date: Feb. 19, 2025

(30) Foreign Application Priority Data
Oct. 4, 2022 (JP) 2022-160124

(51) Int. Cl. G08B 21/04

(52) U.S. Cl. CPC G08B 21/0438; G08B 21/043

(57) ABSTRACT

An object is to contribute to improvement in the accuracy of detection of an abnormal situation. There are provided a specification unit that specifies at least one of an item or a load of work performed by a user, and a detection unit that detects an abnormal situation of the user on the basis of a determination criterion according to at least one of the item or the load of work specified by the specification unit via a sensor provided on the user or around the user.

### TECHNICAL FIELD

The present invention relates to an information processing device, an information processing method, and a program.

### BACKGROUND ART

In recent years, automation and labor saving of work in factories, agricultural workplaces, and the like have progressed, and work can be performed with a small number of personnel. On the other hand, if the number of personnel decreases, there is a high possibility that other workers do not notice even if an abnormal situation such as falling over (falling over by tripping over something, falling over due to poor physical condition, and the like) or falling from a high place occurs to a worker. In particular, in a case where the worker cannot move due to an injury caused by falling over or falling from a high place, or in a case where the worker loses consciousness, and the like, there is a possibility that the worker is caught in a serious situation.

In order to avoid being caught in such a serious situation, a technology has been proposed using a sensor for detecting an abnormal situation such as falling over.

Patent Literature 1 discloses a technique in which an acceleration sensor is attached to a required position on a person and falling over is detected when acceleration obtained from the sensor exceeds a preset reference acceleration.

### CITATIONS LIST

### Patent Literature

Patent Literature 1: JP 2004-252618 A

### SUMMARY OF INVENTION

### Technical Problems

There is a demand for improving the accuracy of detection of an abnormal situation. Therefore, it is conceivable to increase the sensitivity of a sensor in order to detect abnormal situations without omission, but if the sensitivity is increased too much, excessive detection occurs. In addition, an abnormal situation that is likely to occur and an abnormal situation that is less likely to occur may differ depending on the user's situation. For example, in a case where the user is working at a flat and low position, there is almost no possibility that the user falls from a high place.

Therefore, if a fall is detected in a situation where a fall of the user from a high place cannot occur, the possibility of erroneous detection increases. In related art, in such a situation, there is a limit to the accuracy of detection of an abnormal situation.

The present invention has been made in view of such problems, and an object of the present invention is to contribute to improvement in the accuracy of detection of an abnormal situation.

### Solutions to Problems

In order to achieve the above object, an information processing device according to the present invention includes: a specification unit that specifies at least one of an item or a load of work performed by a user; and a detection unit that detects an abnormal situation of the user with a determination criterion according to at least one of the item or the load of work specified by the specification unit via a sensor provided on the user or around the user.

### ADVANTAGEOUS EFFECTS OF INVENTION

According to the present invention, it is possible to contribute to improvement in the accuracy of detection of an abnormal situation.

### BRIEF DESCRIPTION OF DRAWINGS

FIG. 1 is a diagram illustrating an example of a system configuration of a detection system.

FIG. 2 is a diagram illustrating an example of a hardware configuration of a server device.

FIG. 3 is a diagram illustrating an example of a reference value table.

FIG. 4 is a diagram illustrating an example of a sensitivity table.

FIG. 5 is a diagram illustrating an example of a hardware configuration of a terminal device.

FIG. 6 is a diagram illustrating an example of a functional configuration of a server device.

FIG. 7 is a flowchart illustrating an example of detection processing.

FIG. 8 is a diagram illustrating an example of a sensitivity table.

FIG. 9 is a flowchart illustrating an example of detection processing.

FIG. 10 is a diagram illustrating an example of a sensitivity table.

FIG. 11 is a flowchart illustrating an example of detection processing.

FIG. 12 is a diagram illustrating an example of a reference value table.

FIG. 13 is a diagram illustrating an example of a Sensitivity table.

FIG. 14 is a flowchart illustrating an example of detection processing.

### DESCRIPTION OF EMBODIMENTS

### First Embodiment

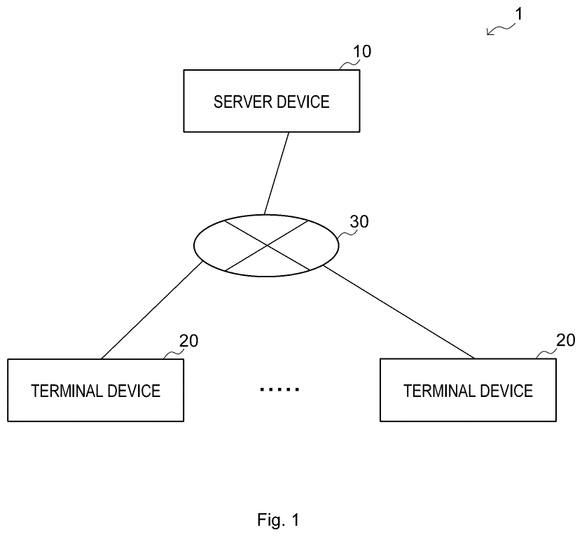

FIG. 1 is a diagram illustrating an example of a system configuration of a detection system 1 of the present embodiment. The detection system 1 is a system that detects an abnormal situation of a user, and includes a server device 10 and a terminal device 20 provided on each of one or more users who perform work such as agricultural work on a farm and work in a factory. The server device 10 and each of the terminal devices 20 are connected via a network 30.

The server device 10 is an information processing device such as a server computer or a general-purpose computer that detects an abnormal situation of the user on the basis of signals acquired via various sensors. In the present embodiment, the server device 10 detects falling over, falling from a high place, impact, lying down immobile, fatigue, and high heart rate as the abnormal situation. Falling over means falling down. Falling from a high place means falling from a high place. Impact means that acceleration of a certain level or more is applied.

Lying down immobile means that the user falls over and does not move. Fatigue means accumulated fatigue. High heart rate means that the heart rate is higher than normal.

The terminal device 20 is an information processing device such as a smartphone or a smart watch that includes a sensor and transmits a signal acquired via the sensor to the server device 10.

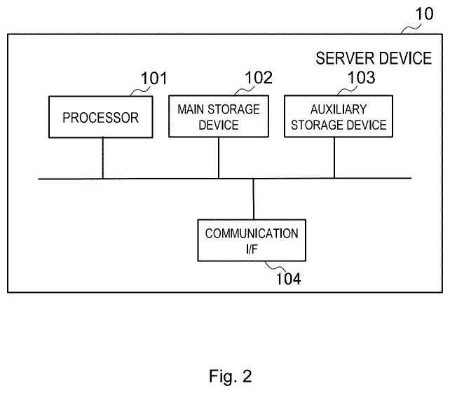

FIG. 2 is a diagram illustrating an example of a hardware configuration of the server device 10.

The server device 10 includes a processor 101, a main storage device 102, an auxiliary storage device 103, and a communication interface (I/F) 104.

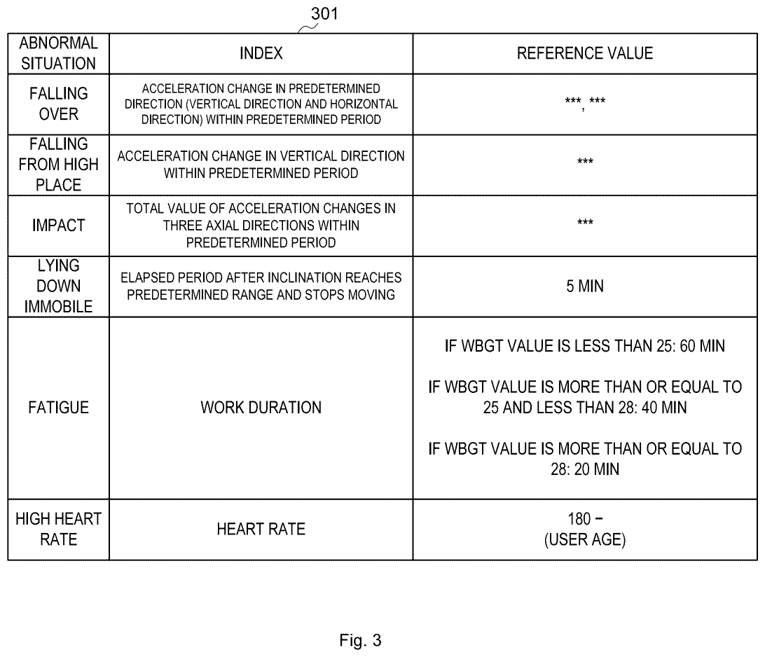

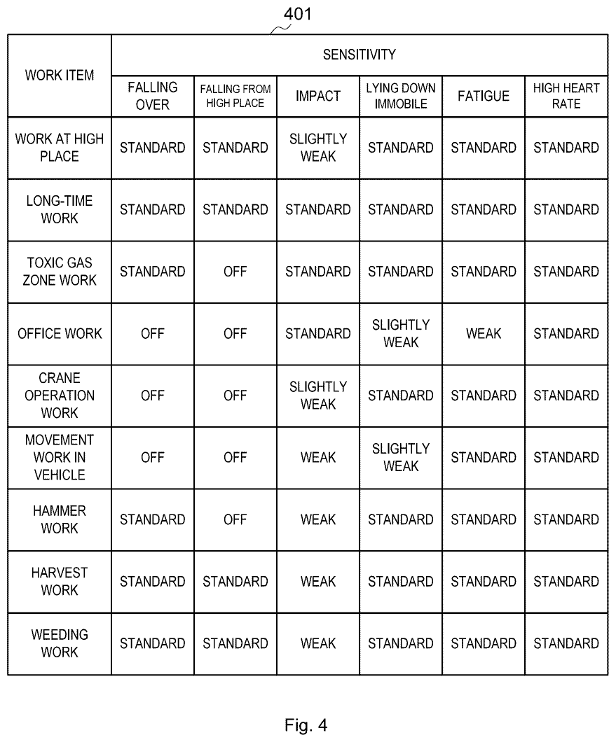

The processor 101 is a control device that controls the server device 10. The main storage device 102 is a storage device such as a random access memory (RAM) used for temporarily saving information, developing a program, and the like. The auxiliary storage device 103 is a storage device such as a hard disk drive (HDD) or a solid state drive (SSD) that stores various kinds of information such as a reference value table 301 described later with reference to FIG. 3 and a sensitivity table 401 described later with reference to FIG. 4, and various kinds of programs. The communication I/F 104 is an interface used for communication with an external device such as the terminal device 20 via the network 30.

The reference value table 301 will be described with reference to FIG. 3.

The reference value table 301 shows a correspondence between an abnormal situation and an index and a reference value used to determine the abnormal situation. The reference value is a value indicating what kind of value the corresponding index has to be determined as in order to be an abnormal situation. In the present embodiment, the server device 10 detects an abnormal situation when the value of the index according to the abnormal situation becomes more than or equal to the reference value.

The reference value table 301 includes items of an “abnormal situation” indicating an abnormal situation, an index used for determining a corresponding abnormal situation, an “index” indicating a reference value, and a “reference value”.

In the present embodiment, the reference value table 301 includes indices and reference values according to abnormal situations of falling over, falling from a high place, impact, lying down immobile, fatigue, and high heart rate.

In the present embodiment, the index used to detect falling over is a change value of acceleration applied to the user in a vertical direction and a horizontal direction in a predetermined period (for example, 1 second, 2 seconds, and the like). In addition, the index used to detect falling from a high place is a change value of acceleration applied to the user in a vertical direction in a predetermined period. In addition, the index used to detect impact is a scalar value of a synthetic vector of accelerations of three axes that can be detected by an acceleration sensor provided on the user in a predetermined period. In addition, the index used to detect lying down immobile is an elapsed period after an inclination of the terminal device 20 becomes a value within a predetermined range when the user takes a predetermined posture (a collapsed posture; a posture prostrate on a desk, a steering wheel, or the like; a posture hanging by a safety belt, or the like) and the movement of the user stops. In the present embodiment, this predetermined range is a range determined in advance as a range of inclination that can be taken by the terminal device 20 when the user lies down.

However, this range may be adjusted to an arbitrary range according to designation or the like from the user. In addition, the index used to detect fatigue is a duration of work. Note that, in the present embodiment, a plurality of reference values used for fatigue detection is determined according to a value (wet-bulb globe temperature (WBGT) value) of a heat index (WBGT). The index used to detect high heart rate is the heart rate of the user. Note that each index is acquired by the terminal device 20 and transmitted to the server device 10. This process will be described later.

The sensitivity table 401 will be described with reference to FIG. 4.

The sensitivity table 401 indicates a correspondence between an item of work (in the following, work item) that the user is performing and a detection sensitivity of each abnormal situation. Here, detection sensitivity is a measure indicating ease of detection of an abnormal situation to be detected, and the higher the detection sensitivity, the easier the detection. In the present embodiment, the detection sensitivity takes any one of a plurality of ranked values (in the present embodiment, four values of “standard”, “slightly weak”, “weak”, and “off” are listed in descending order). Among “standard”, “slightly weak”, “weak”, and “off”, the highest sensitivity is “standard”, the second highest is “slightly weak”, the third highest is “weak”, and the lowest is “off”. In addition, the sensitivity “off” indicates that detection is not performed.

In the present embodiment, the server device 10 detects an abnormal situation of the user having the terminal device 20 with the sensitivity according to the work item of the work performed by the user stored in the sensitivity table 401. When detecting an abnormal situation, in a case where the detection sensitivity is either “slightly weak” or “weak”, the server device 10 corrects the value of the reference value used for determination of the abnormal situation by multiplying the value by a coefficient according to the detection sensitivity, and detects an abnormal situation if the value of the index used for determination of the abnormal situation is more than or equal to the corrected reference value. This coefficient is a value larger than 1, and the smaller the corresponding sensitivity, the larger the coefficient. For example, it is assumed that a coefficient of 1.2 is set for “slightly weak” and a coefficient of 1.5 is set for “weak”. As a result, in a case where a value of an index (sensor value) that is determined to be an abnormal situation with the detection sensitivity “standard” is detected, since the value does not exceed the reference value with the detection sensitivity “weak”, the situation is not determined to be abnormal, and it is possible to prevent excessive determination of an abnormal situation. In the present embodiment, low detection sensitivity means that the reference value is high, and high detection sensitivity means that the reference value is low.

As described above, the server device 10 detects the abnormal situation of the user on the basis of a determination criterion according to the work item of the work performed by the user. Here, the determination criterion is a criterion indicating how to detect an abnormal situation, and in the present embodiment, is a criterion indicating what kind of index value should exceed what kind of reference value to be an abnormal situation.

In the present embodiment, the detection sensitivity is determined in advance such that the detection sensitivity for an abnormal situation determined in advance as an abnormal situation in which erroneous detection is assumed in work is less than or equal to a predetermined threshold (for example, “slightly weak”, “weak”, and the like).

For example, there is almost no possibility that the user falls from a high place for work items other than work having a possibility of falling from a high place, such as work at a high place (work at a position at a height higher than or equal to a predetermined height (for example, 5 m or the like) from the ground), work involving ascending and descending a stepladder or the like (agricultural work such as harvest work and weeding work), and work on a mountain slope (agricultural work or the like). Therefore, erroneous detection is assumed when falling from a high place is detected for such a work item. Therefore, in the present embodiment, the detection sensitivity of falling from a high place for such a work item is determined to be a predetermined value (in the present embodiment, “weak”) or less. In the example of FIG. 4, regarding work in a place where a toxic gas can be generated (toxic gas zone work), office work, crane operation work, movement work in a vehicle, and work using a hammer (hammer work), it is assumed that erroneous detection of falling from a high place is assumed, and the detection sensitivity of falling from a high place is set to “weak” or less.

In addition, in a case where a situation that can be confused with an abnormal situation is likely to occur in work, erroneous detection of an abnormal situation is assumed. Therefore, in the present embodiment, the detection sensitivity is determined in advance so that the detection sensitivity for such an abnormal situation is less than or equal to a predetermined threshold (for example, “slightly weak”, “weak”, and the like).

In work such as work using a hammer, work using agricultural tools, and movement work in a vehicle, acceleration is applied to the user when using the hammer or agricultural tools, starting or stopping the vehicle, or the like. This acceleration may be confused with impact on the user. Therefore, it is assumed that impact is erroneously detected. Therefore, in the present embodiment, the sensitivity of the impact detection is determined to be less than or equal to a predetermined threshold for a work item that may cause a situation in which acceleration more than or equal to a certain level is applied to the user, such as work using a hammer or agricultural tools or movement work in a vehicle. In the example of FIG. 4, for movement work in a vehicle, hammer work, harvest work, and weeding work, the sensitivity of the impact detection is determined to be “weak” or less.

In addition, in the present embodiment, the detection sensitivity is determined in advance such that the detection sensitivity for an abnormal situation determined in advance as an abnormal situation in which serious harm to the user is assumed in work is more than or equal to a predetermined threshold (for example, “weak”, “standard”, and the like). Since falling from a high place tends to cause serious harm to the user, it is desired to prevent non-detection as much as possible. In the example of FIG. 4, the detection sensitivity is set to “standard” or higher for work items having a possibility of falling from a high place, such as work at a high place, work involving ascending and descending a stepladder or the like, and work on a mountain slope.

When receiving an instruction to change the sensitivity for detection of each abnormal situation for each work item based on an operation of an input device of the server device 10 by the user, the processor 101 updates the sensitivity table 401 so as to change the sensitivity for detection of each abnormal situation for each work item. In addition, the processor 101 may receive an instruction from the terminal device 20 to change content of the sensitivity table 401.

By using the sensitivity table 401 updated in this manner, the server device 10 can detect an abnormal situation based on a determination criterion assumed by the user.

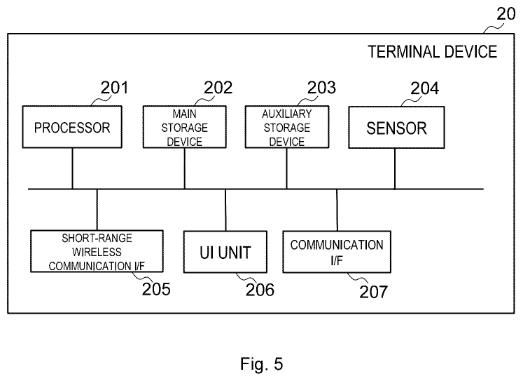

FIG. 5 is a diagram illustrating an example of a hardware configuration of each terminal device 20.

The terminal device 20 includes a processor 201, a main storage device 202, an auxiliary storage device 203, a sensor 204, a short-range wireless communication I/F 205, a UI unit 206, and a communication I/F 207.

The processor 201 is a control device that controls the terminal device 20. The main storage device 202 is a storage device such as a RAM used for temporarily saving information, developing a program, and the like. The auxiliary storage device 203 is a storage device such as an HDD or an SSD that stores various information and various programs. The sensor 204 is a sensor that detects predetermined information. In the present embodiment, the sensor 204 includes an acceleration sensor that detects acceleration in three axial directions perpendicular to each other, an inclination sensor that detects inclination of the terminal device 20, a camera, a heart rate sensor that detects the heart rate of the user, a position sensor that receives a GNSS signal and detects a position, and an altimeter. The short-range wireless communication I/F 205 is an interface used for short-range wireless communication with an environment sensor (sensor for detecting wet-bulb temperature, black-bulb temperature, dry-bulb temperature, and the like) and a beacon that transmits a signal indicating position information, and the like, provided in an environment where the user performs work. Hereinafter, the signal indicating position information transmitted by the beacon is referred to as a beacon signal. The processor 201 acquires a wet-bulb temperature, a black-bulb temperature, and a dry-bulb temperature in the environment in which the user performs work from the environment sensor via the short-range wireless communication I/F 205. The UI unit 206 includes an input unit such as a touch panel, a hard button, or a microphone used to input information from the user, and an output unit such as a monitor or a speaker used to present information to the user. The communication I/F 207 is an interface used for communication or the like with an external device such as the server device 10 via the network 30.

Note that, in the present embodiment, the terminal device 20 includes a heart rate sensor and detects the heart rate of the user. However, as another example, the terminal device 20 may acquire the heart rate of the user by another method. For example, the processor 201 of the terminal device 20 may acquire the heart rate of the user detected by an external device (for example, a smart watch or the like) having a heart rate sensor from the external device via the short-range wireless communication I/F 205.

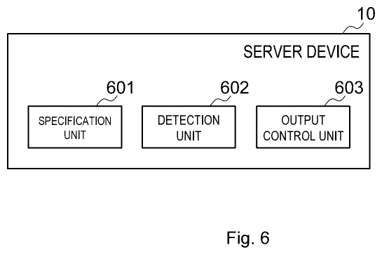

A functional configuration of the server device 10 will be described with reference to FIG. 6.

The processor 101 of the server device 10 functions as a specification unit 601, a detection unit 602, and an output control unit 603 by executing a program stored in the auxiliary storage device 103 or the like. Processing described below mainly by the specification unit 601, the detection unit 602, and the output control unit 603 is actually mainly by the processor 101.

The specification unit 601 specifies a work item of the work performed by the user having the terminal device 20. The detection unit 602 detects an abnormal situation of the user on the basis of a determination criterion according to a work item specified by the specification unit 601 via at least one of the sensor 204 of the terminal device 20 and an external sensor (environment sensor or the like). The output control unit 603 outputs warning information about an abnormal situation detected by the detection unit 602.

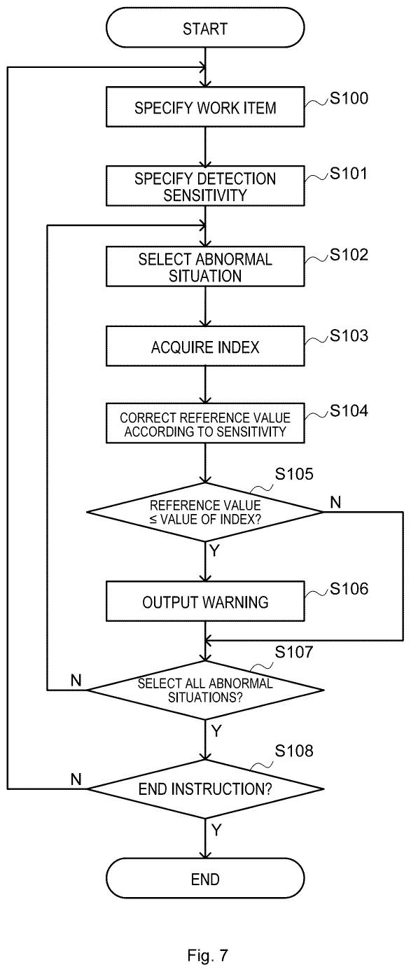

With reference to FIG. 7, detection processing of an abnormal situation of the user having the terminal device 20 executed by the server device 10 will be described.

When receiving an instruction from the terminal device 20 to start the process of detecting an abnormal situation of the user, the processor 101 starts the processing of FIG. 7. When receiving the instruction to start the process of detecting an abnormal situation from the user via the UI unit 206, the processor 201 of the terminal device 20 transmits the instruction to start the abnormal situation detection processing to the server device 10. In addition, when transmitting the instruction to start the process of detecting an abnormal situation, the processor 201 periodically detects the acceleration applied to the terminal device 20 (user), the inclination of the terminal device 20, and the heart rate of the user via the sensor 204, and transmits these detected items of information to the server device 10. However, the processor 201 may instruct the sensor 204 to transmit a value of the detected signal only when a specified threshold is exceeded. In this case, the sensor 204 transmits the detected signal to the processor 201 if a signal exceeding the specified threshold is detected. In addition, when transmitting the instruction to start the process of detecting an abnormal situation, the processor 201 periodically acquires a signal detected from the environment sensor and the beacon provided in the environment in which the user performs work via the short-range wireless communication I/F 205. Then, the processor 201 periodically transmits signals acquired from the environment sensor and the beacon to the server device 10.

In step S100, the specification unit 601 specifies a work item of the work performed by the user having the terminal device 20. In the present embodiment, the specification unit 601 specifies the work item of the work performed by the user on the basis of the position of the terminal device 20 (position of user). More specifically, the specification unit 601 inquires of the terminal device 20 about the position of the terminal device 20. In response to the inquiry, the processor 201 of the terminal device 20 specifies the position (latitude, longitude, altitude) of the terminal device 20 via the position sensor and the altimeter included in the sensor 204. However, the processor 201 may specify the position of the terminal device 20 by another method. For example, in a case where there is a device that transmits a beacon signal indicating information of a position where the terminal device 20 exists around the terminal device 20, the processor 201 may receive the beacon signal and specify the position from the received beacon signal. The processor 201 transmits the specified position to the server device 10. The specification unit 601 acquires the work item according to the position transmitted from the terminal device 20 from correspondence information between the position and the work item stored in advance in the auxiliary storage device 103, and specifies the acquired work item as the work item of the user's work.

After completion of the processing in step S100, the specification unit 601 advances the processing to step S101. The processing in step S100 is an example of a specification step.

In step S101, the detection unit 602 specifies the detection sensitivity of each abnormal situation for the work item specified in step S100 from the sensitivity table 401 stored in the auxiliary storage device 103. After completion of the processing in step S101, the specification unit 601 advances the processing to step S102.

In step S102, the detection unit 602 selects one from a plurality of abnormal situations (falling over, falling from a high place, impact, lying down immobile, fatigue, high heart rate) to be detected. Hereinafter, the abnormal situation selected in the immediately preceding step S102 is referred to as a selected abnormal situation. After completion of the processing in step S102, the specification unit 601 advances the processing to step S103. Note that, when the detection sensitivity of the selected abnormal situation specified in step S101 is “off”, the detection unit 602 advances the processing to step S107 after completion of the processing of step S102.

In step S103, the detection unit 602 specifies an index according to the selected abnormal situation from the reference value table 301. Then, the detection unit 602 acquires a value of the specified index. More specifically, the detection unit 602 is configured as follows.

In a case where the selected abnormal situation is falling over, the detection unit 602 acquires a value of change in acceleration in the vertical direction and the horizontal direction applied to the terminal device 20 in a predetermined period as a value of the index on the basis of information on acceleration applied to the terminal device 20 and received from the terminal device 20.

In a case where the selected abnormal situation is falling from a high place, the detection unit 602 acquires a converted value of the vertical acceleration applied to the terminal device 20 in the predetermined period as a value of the index on the basis of the information on acceleration applied to the terminal device 20 and received from the terminal device 20.

In a case where the selected abnormal situation is impact, the detection unit 602 acquires a scalar value of a synthetic vector of accelerations of three axes applied to the terminal device 20 as a value of the index on the basis of the information on acceleration applied to the terminal device 20 and received from the terminal device 20.

In a case where the selected abnormal situation is lying down immobile, the detection unit 602 acquires the following values on the basis of the information on the inclination of the terminal device 20 and the acceleration applied to the terminal device 20 and received from the terminal device 20. That is, the detection unit 602 acquires as a value of the index a period in which the inclination of the terminal device 20 is within a predetermined range according to the work item of the work performed by the user, and the acceleration applied to the terminal device 20 is 0.

In a case where the selected abnormal situation is fatigue, the detection unit 602 acquires a work duration (an elapsed period from the start of the abnormal situation detection processing) of the user having the terminal device 20 as a value of the index. In addition, the detection unit 602 submits a request to the terminal device 20 for the wet-bulb temperature, the black-bulb temperature, and the dry-bulb temperature of the environment in which the user performs work. In response to the request, the processor 201 acquires the wet-bulb temperature, the black-bulb temperature, and the dry-bulb temperature from the environment sensor via the short-range wireless communication I/F 205, and transmits the wet-bulb temperature, the black-bulb temperature, and the dry-bulb temperature to the server device 10. The detection unit 602 obtains a WBGT value based on the received wet-bulb temperature, black-bulb temperature, and dry-bulb temperature.

In a case where the selected abnormal situation is high heart rate, the detection unit 602 acquires the heart rate of the user received from the terminal device 20 as a value of the index.

After completion of the processing in step S103, the specification unit 601 advances the processing to step S104.

In step S104, the detection unit 602 acquires a reference value according to the selected abnormal situation from the reference value table 301. Note that, in a case where the selected abnormal situation is fatigue, the detection unit 602 acquires the reference value according to the WBGT value specified in step S103 from the reference value table 301. The detection unit 602 corrects the acquired reference value according to the detection sensitivity of the selected abnormal situation specified in step S101. Note that, in a case where the selected abnormal situation is falling over, the detection unit 602 corrects each of the two reference values.

More specifically, if the sensitivity for the selected abnormal situation is “standard”, the detection unit 602 does not correct the reference value. In addition, if the sensitivity to the selected abnormal situation is “slightly weak”, the detection unit 602 corrects the reference value by multiplying the reference value by a predetermined coefficient larger than 1. In addition, if the sensitivity to the selected abnormal situation is “weak”, the detection unit 602 corrects the reference value by multiplying the reference value by a predetermined coefficient larger than the coefficient according to “slightly weak”. Note that the coefficient according to each of the sensitivities “slightly weak” and “weak” may be a different value or the same value for each abnormal situation of the detection target. After completion of the processing in step S104, the specification unit 601 advances the processing to step S105.

In step S105, the detection unit 602 determines whether or not the value of the index acquired in the immediately preceding step S103 is more than or equal to the reference value corrected according to the sensitivity in the immediately preceding step S104.

Note that, in a case where the selected abnormal situation is falling over, the detection unit 602 determines that the value of the index is more than or equal to the reference value when both of the values of the two indexes (change value of acceleration in vertical direction and change value of acceleration in horizontal direction) are more than or equal to the corresponding reference value.

In a case where the detection unit 602 determines that the value of the index is more than or equal to the reference value, the detection unit 602 detects the selected abnormal situation and advances the processing to step S106. In addition, in a case where the detection unit 602 determines that the value of the index is less than the reference value, it is determined that the selected abnormal situation has not occurred, and the processing is advanced to step S107. The processing in step S105 is an example of a detection step.

In step S106, the output control unit 603 outputs information indicating a warning about the occurrence of the selected abnormal situation to a predetermined output destination. In the present embodiment, the output control unit 603 transmits information indicating a warning about the selected abnormal situation to an information processing device of an administrator who manages the user, and causes a display unit of the information processing device to display the information. The information indicating a warning about the abnormal situation is, for example, information indicating that the abnormal situation has occurred, information prompting a measure against the occurrence of the abnormal situation, and the like.

Note that, in the present embodiment, when the work item specified in step S100 is “harvesting work”, the output control unit 603 transmits alert information indicating that there is a possibility of falling from a high place to the terminal device 20, causes the UI unit 206 to display the alert information, and presents a falling from a high place alert to the user. This is because if the harvest is at a high place, the user may be distracted with his/her step.

After completion of the processing of step S106, the output control unit 603 advances the processing to step S107.

In step S107, the detection unit 602 determines whether or not all of the plurality of abnormal situations to be detected have been selected as the selected abnormal situation in step S102. In a case where the detection unit 602 determines that all of the plurality of abnormal situations to be detected have been selected as the selected abnormal situation in step S102, the processing is advanced to step S108. If the detection unit 602 determines that there is an abnormal situation that has not been selected as the selected abnormal situation in step S102 among the plurality of abnormal situations to be detected, the processing is advanced to step S102.

In step S108, the detection unit 602 determines whether an instruction to end the abnormal situation detection processing has been received from the terminal device 20. If the detection unit 602 determines that an instruction to end the abnormal situation detection processing has been received from the terminal device 20, the processing of FIG. 7 is completed. In addition, in a case where the detection unit 602 determines that the instruction to end the abnormal situation detection processing has not been received from the terminal device 20, the detection unit 602 clears a history of abnormal situations selected as the selected abnormal situation for the plurality of abnormal situations to be detected, and advances the processing to step S100.

As described above, with the configuration of the present embodiment, the server device 10 can contribute to improvement in the accuracy of detection of an abnormal situation by detecting the abnormal situation on the basis of a determination criterion according to the work item of the work performed by the user.

In addition, in the present embodiment, the server device 10 sets the detection sensitivity to a predetermined value or less for an abnormal situation determined in advance as an abnormal situation in which erroneous detection is assumed for the work item being performed by the user. As a result, the server device 10 can reduce erroneous detection of the abnormal situation.

In addition, the server device 10 sets the detection sensitivity to a predetermined value or more for an abnormal situation determined in advance as an abnormal situation in which harm to the user is serious for the work item of the work performed by the user. As a result, the server device 10 can reduce non-detection of the abnormal situation.

### Second Embodiment

In the present embodiment, the server device 10 detects an abnormal situation based on a determination criterion according to not the work item of the work performed by the user but a load of the work (in the following, work load) performed by the user.

Hereinafter, the detection system 1 of the present embodiment will be described in terms of differences from the first embodiment.

A system configuration of the detection system 1 of the present embodiment is similar to that of the first embodiment. In addition, hardware configurations of the server device 10 and the terminal device 20 of the present embodiment are similar to those of the first embodiment.

A functional configuration of the server device 10 of the present embodiment will be described.

Similarly to the first embodiment, the processor 101 of the present embodiment functions as the specification unit 601, the detection unit 602, and the output control unit 603.

The specification unit 601 of the present embodiment specifies the work load of the work performed by the user having the terminal device 20. In addition, the detection unit 602 detects an abnormal situation of the user on the basis of a determination criterion according to the work load specified by the specification unit 601 via at least one of the sensor 204 of the terminal device 20 or an external sensor (environment sensor or the like). The output control unit 603 is similar to that of the first embodiment.

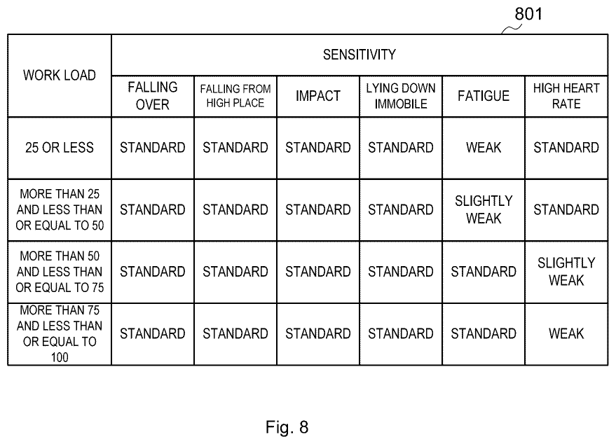

In the present embodiment, the server device 10 uses a sensitivity table 801 instead of the sensitivity table 401. The sensitivity table 801 is stored in advance in the auxiliary storage device 103. The sensitivity table 801 of the present embodiment will be described with reference to FIG. 8.

The sensitivity table 801 according to the present embodiment indicates correspondence between the work load and the detection sensitivity of each abnormal situation.

The work load is a scale indicating that the larger the work load is, the larger the load involved in the work is. In the present embodiment, the work load takes a value of 0 or more and 100 or less.

In the present embodiment, the value of the work load is ranked into four ranks of a rank of 25 or less, a rank of more than 25 and 50 or less, a rank of more than 50 and 75 or less, and a rank of more than 75 and 100 or less.

In the present embodiment, for an abnormal situation determined in advance as an abnormal situation in which erroneous detection is assumed for the value of the work load, the detection sensitivity is set to be less than or equal to a threshold.

The sensitivity of fatigue detection is set to be “slightly weak” or less with respect to the values of the work loads of the rank of 25 or less and the rank of more than 25 and 50 or less. This is because an accumulation of fatigue is considered to be smaller as the work load is smaller.

In addition, in the present embodiment, the detection sensitivity is set to be higher than or equal to the threshold for an abnormal situation determined in advance as an abnormal situation in which harm to the user is serious with respect to the value of the work load.

In addition, the sensitivity to detect high heart rate is determined to be higher than or equal to “standard” with respect to the values of the work loads ranked 25 or lower and ranked higher than 25 and 50 or lower. This is because the smaller the work load, the smaller the factor of an increase in the heart rate, and thus the heart rate is likely to increase due to an abnormality of the heart despite such a situation. However, in order to avoid the risk of a high heart rate when the work load is large, the detection sensitivity of high heart rate may be set to be larger as the work load is larger.

As a result, the detection unit 602 can change the detection sensitivity of “fatigue” and “high heart rate” according to the value of the work load. In the present embodiment, the detection unit 602 increases the detection sensitivity of “fatigue” and “high heart rate” as the value of the work load increases.

Note that the detection unit 602 may also change the detection sensitivity according to the value of the work load for abnormal situations other than “fatigue” and “high heart rate”. If the period in which the value of the work load is more than or equal to a predetermined threshold continues to be more than or equal to a predetermined period threshold, the detection unit 602 may raise the detection sensitivity to be more than or equal to the predetermined threshold for abnormal situations (for example, falling over, falling from a high place, impact, lying down immobile, and the like) other than “fatigue” and “high heart rate”, considering that the risk of occurrence of industrial accidents increases due to a decrease in the physical strength and judgment of a worker. For example, the detection unit 602 may raise the detection sensitivity to a standard for the detection sensitivity less than the standard among falling over, falling from a high place, impact, and lying down immobile.

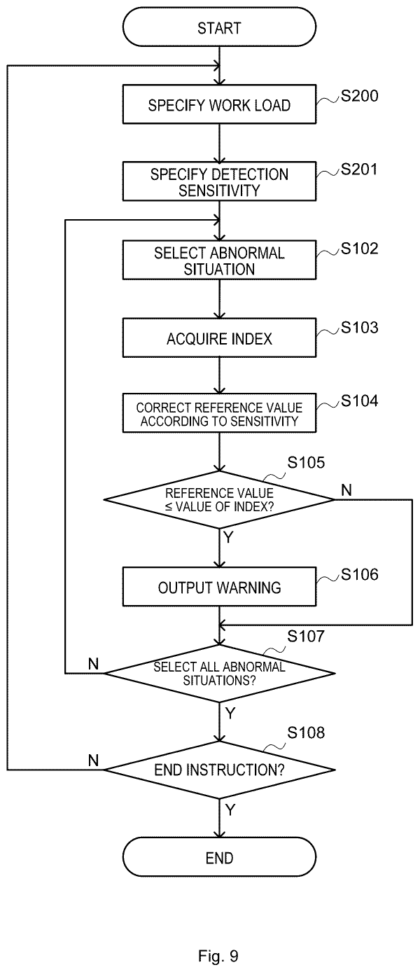

An abnormal situation detection process according to the present embodiment will be described with reference to FIG. 9. Hereinafter, differences from the processing of FIG. 7 in the processing of FIG. 9 will be described.

The processing of FIG. 9 is different from the processing of FIG. 7 in that the processes of steps S200 and S201 are included instead of the processes of steps S100 and S101.

In step S200, the specification unit 601 specifies the work load of the work performed by the user on the basis of the heart rate of the user in a previous predetermined period acquired from the terminal device 20. Note that, in a case where a break period of the user is included in the predetermined period, the specification unit 601 specifies the work load on the basis of the heart rate of the user in the period after the break period. In the present embodiment, the specification unit 601 obtains an average heart rate of the user for each certain section (for example, an interval of a predetermined number of seconds or the like) within the predetermined period (alternatively, a period after the break period). Then, the specification unit 601 determines whether the average heart rate is higher than or equal to a predetermined threshold for each section. The specification unit 601 specifies the work load by multiplying the number of sections in which the average heart rate is higher than or equal to the predetermined threshold by a predetermined coefficient.

After completion of the processing in step S200, the specification unit 601 advances the processing to step S201.

In step S201, the detection unit 602 specifies the detection sensitivity of each abnormal situation according to the work load specified in step S200 from the sensitivity table 801 indicating the correspondence between the work load and the detection sensitivity of the abnormal situation.

As described above, with the configuration of the present embodiment, the server device 10 can contribute to improvement in the accuracy of detection of an abnormal situation by detecting the abnormal situation on the basis of a determination criterion according to the work load of the work performed by the user.

In addition, in the present embodiment, the server device 10 sets the detection sensitivity to a predetermined value or less for an abnormal situation determined in advance as an abnormal situation in which erroneous detection is assumed with respect to the work load of the work performed by the user. As a result, the server device 10 can reduce erroneous detection of the abnormal situation.

In addition, the server device 10 sets the detection sensitivity to a predetermined value or more for an abnormal situation determined in advance as an abnormal situation in which harm to the user is serious with respect to the work load of the work performed by the user. As a result, the server device 10 can reduce non-detection of the abnormal situation.

### Third Embodiment

In the present embodiment, the server device 10 detects an abnormal situation based on a determination criterion according to the work item of the work performed by the user and the work load of the work performed by the user.

Hereinafter, the detection system 1 of the present embodiment will be described in terms of differences from the first embodiment.

A system configuration of the detection system 1 of the present embodiment is similar to that of the first embodiment. In addition, hardware configurations of the server device 10 and the terminal device 20 of the present embodiment are similar to those of the first embodiment.

A functional configuration of the server device 10 of the present embodiment will be described.

Similarly to the first embodiment, the processor 101 of the present embodiment functions as the specification unit 601, the detection unit 602, and the output control unit 603.

The specification unit 601 of the present embodiment specifies the work item and the work load of the work performed by the user having the terminal device 20. In addition, the detection unit 602 detects an abnormal situation of the user on the basis of a determination criterion according to the work item and the work load specified by the specification unit 601. The output control unit 603 is similar to that of the first embodiment.

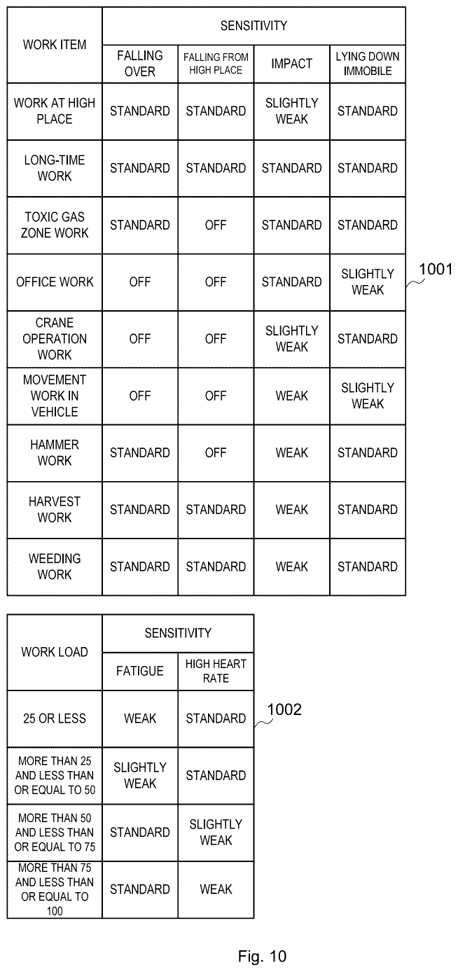

In the present embodiment, the server device 10 uses sensitivity tables 1001 and 1002 instead of the sensitivity table 401. The sensitivity tables 1001 and 1002 are stored in the auxiliary storage device 103 in advance. The sensitivity tables 1001 and 1002 of the present embodiment will be described with reference to FIG. 10.

The sensitivity table 1001 according to the present embodiment is a table indicating correspondence between work items and detection sensitivity for falling over, falling from a high place, impact, and lying down immobile. In addition, the sensitivity table 1002 is a table indicating correspondence between the work load and the detection sensitivity of fatigue and high heart rate.

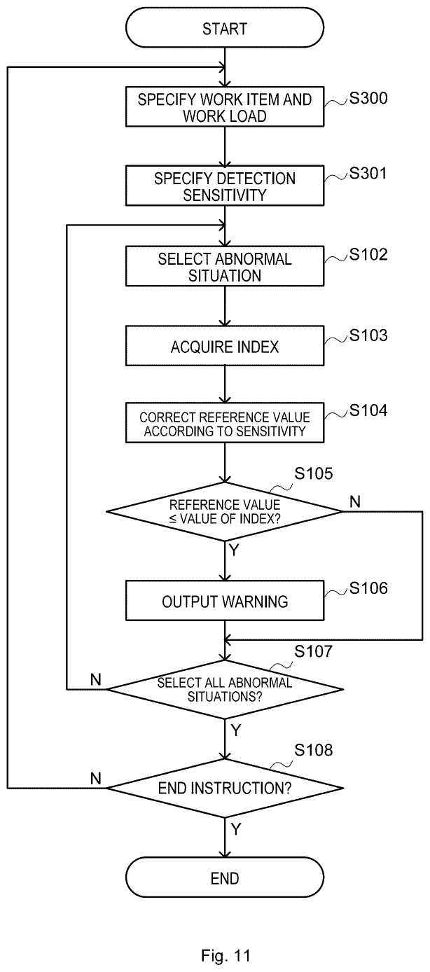

An abnormal situation detection process according to the present embodiment will be described with reference to FIG. 11. Hereinafter, differences from the processing of FIG. 7 in the processing of FIG. 11 will be described.

The processing of FIG. 11 is different from the processing of FIG. 7 in that the processes of steps S300 and S301 are included instead of the processes of steps S100 and S101.

In step S300, the specification unit 601 specifies a work item of work performed by the user in processing similar to that in the first embodiment. In addition, the specification unit 601 specifies a work load of the work performed by the user in the same processing as in the second embodiment.

In step S301, the detection unit 602 specifies the detection sensitivity of each abnormal situation according to the work item and the work load specified in step S100 from the sensitivity tables 1001 and 1002.

As described above, with the configuration of the present embodiment, the server device 10 can contribute to improvement in the accuracy of detection of an abnormal situation by detecting the abnormal situation on the basis of a determination criterion according to the work item and the work load of the work performed by the user.

### Fourth Embodiment

In the present embodiment, the server device 10 detects an abnormal situation based on a determination criterion according to a movement means of the user.

Hereinafter, the detection system 1 of the present embodiment will be described in terms of differences from the first embodiment.

A system configuration of the detection system 1 of the present embodiment is similar to that of the first embodiment. In addition, hardware configurations of the server device 10 and the terminal device 20 of the present embodiment are similar to those of the first embodiment.

In the present embodiment, the abnormal situations of the detection target include mobile object inclination in addition to falling over, falling from a high place, impact, lying down immobile, fatigue, and high heart rate. Mobile object inclination is an abnormal situation in which a mobile object (bicycle, automobile, forklift, heavy machinery, etc.) used by the user is inclined to a certain degree or more, and there is a possibility of falling over. In the present embodiment, a mobile object that can be used by the user includes an inclination sensor, an acceleration sensor, and an internal camera.

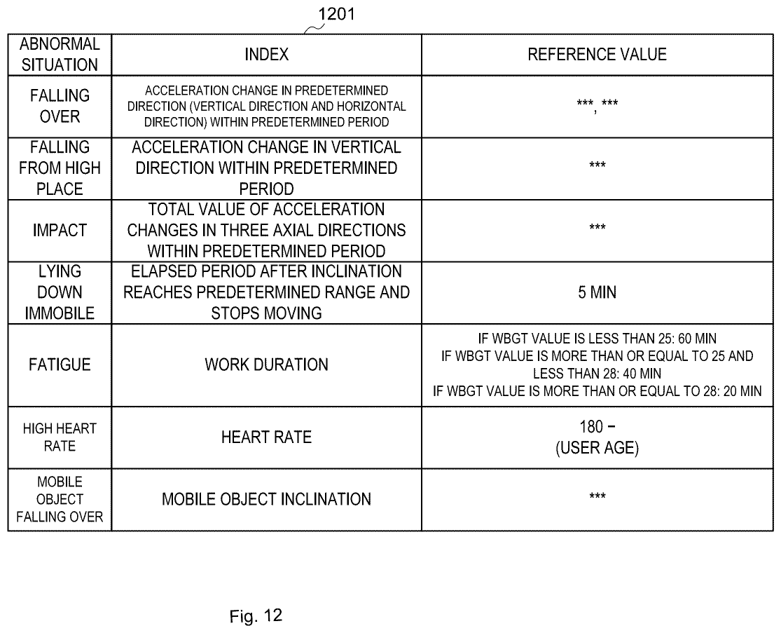

In the present embodiment, the server device 10 uses a reference value table 1201 instead of the reference value table 301. The reference value table 1201 is stored in advance in the auxiliary storage device 103. The reference value table 1201 of the present embodiment will be described with reference to FIG. 12.

In the example of FIG. 12, the reference value table 1201 includes information of an index and a reference value regarding an abnormal situation of a vehicle body falling over in addition to various types of information in the example of FIG. 3. The index used for detecting the inclination of the mobile object is the inclination of the mobile object detected by the inclination sensor provided in the mobile object.

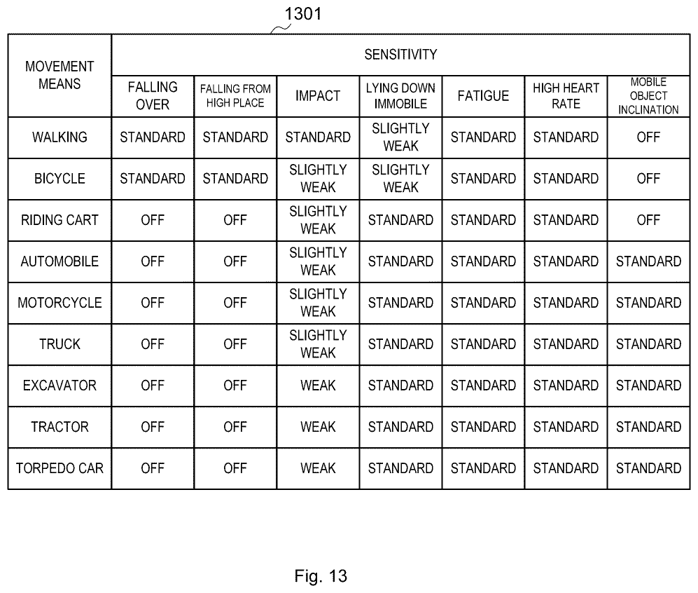

In addition, in the present embodiment, the server device 10 uses a sensitivity table 1301 instead of the sensitivity table 401. The sensitivity table 1301 is stored in advance in the auxiliary storage device 103. The sensitivity table 1301 of the present embodiment will be described with reference to FIG. 13. The sensitivity table 1301 according to the present embodiment indicates correspondence between the movement means that can be taken by the user and the detection sensitivity of each abnormal situation. In the present embodiment, the movement means that can be taken by the user is walking, a bicycle, a riding cart, an automobile, a motorcycle, a truck, an excavator, a tractor, or a torpedo car, but as another example, some of these means may not be included, or other movement means such as a forklift may be included.

In the present embodiment, the detection sensitivity is determined in advance such that the detection sensitivity for an abnormal situation determined in advance as an abnormal situation in which erroneous detection is assumed to occur in work is less than or equal to a predetermined threshold (for example, “slightly weak”, “weak”, and the like).

For example, in a case where the movement means of the user is a means other than walking or a bicycle, it is not assumed that the user falls over or falls from a high place. Therefore, in a case where the movement means of the user is a means other than walking or a bicycle, if falling over or falling from a high place is detected, the abnormal situation is assumed to be erroneous detection.

Therefore, in the present embodiment, the detection sensitivity of falling over or falling from a high place for a movement means other than walking or a bicycle is determined to be a predetermined value (in the present embodiment, “weak”) or less. In the example of FIG. 13, for a riding cart, an automobile, a motorcycle, a truck, an excavator, a tractor, and a torpedo car, it is assumed that erroneous detection of falling over or falling from a high place is not assumed, and thus, the detection sensitivity of falling over or falling from a high place is set to “weak” or less.

In addition, in a case where a situation that can be confused with an abnormal situation is likely to occur in work, erroneous detection of an abnormal situation is assumed. Therefore, in the present embodiment, the detection sensitivity is determined in advance so that the detection sensitivity for such an abnormal situation is less than or equal to a predetermined threshold (for example, “slightly weak”, “weak”, and the like).

In a case where the user is riding on some kind of mobile object, acceleration is applied to the user at the time of starting, stopping, or the like. This acceleration may be confused with impact on the user. Therefore, it is assumed that impact is erroneously detected. Therefore, in the present embodiment, the sensitivity of the impact detection is determined to be less than or equal to a predetermined threshold for a movement means other than walking. In the example of FIG. 13, for a bicycle, a riding cart, an automobile, a motorcycle, a truck, an excavator, a tractor, and a torpedo car, the sensitivity of the impact detection is determined to be “slightly weak” or less.

In addition, in the present embodiment, the detection sensitivity is determined in advance such that the detection sensitivity for an abnormal situation determined in advance as an abnormal situation in which serious harm to the user is assumed in work is more than or equal to a predetermined threshold. In a case where the user is on a mobile object such as an automobile, if the user is in a lying down immobile state, it is assumed that the mobile object moves unintentionally, which leads to an accident, and harm to the user is serious. Therefore, in a case where the user is on such a mobile object, it is desired to prevent non-detection of lying down immobile as much as possible. In the example of FIG. 13, for a riding cart, an automobile, a motorcycle, a truck, an excavator, a tractor, and a torpedo car, the detection sensitivity of lying down immobile is determined to be “standard” or more.

A functional configuration of the server device 10 of the present embodiment will be described.

Similarly to the first embodiment, the processor 101 of the present embodiment functions as the specification unit 601, the detection unit 602, and the output control unit 603.

The specification unit 601 of the present embodiment specifies a movement means of the user having the terminal device 20. In addition, the detection unit 602 detects an abnormal situation of the user on the basis of a determination criterion according to the work load specified by the specification unit 601 via at least one of the sensor 204 and an external sensor. The output control unit 603 is similar to that of the first embodiment.

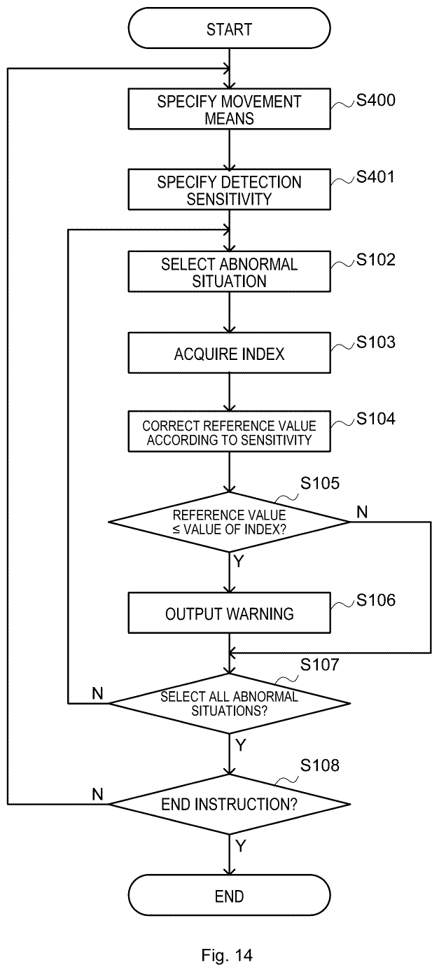

An abnormal situation detection process according to the present embodiment will be described with reference to FIG. 14. Hereinafter, differences from the processing of FIG. 7 in the processing of FIG. 14 will be described.

The processing of FIG. 14 is different from the processing of FIG. 7 in that the processes of steps S400 and S401 are included instead of the processes of steps S100 and S101.

In step S400, the specification unit 601 specifies the movement means of the user. In the present embodiment, in a case where communication (bi-directional communication or unidirectional communication) is performed between the terminal device 20 included on the user and the communication device included in the mobile object, the specification unit 601 specifies the mobile object as the movement means of the user. More specifically, the specification unit 601 performs as follows.

In the present embodiment, each of the mobile objects on which the user can ride includes a communication device that emits a predetermined beacon signal receivable near the mobile object. In a case where the processor 201 of the terminal device 20 receives the beacon signal from the communication device provided in the mobile object via the short-range wireless communication I/F 205, the processor 201 transmits the received beacon signal to the server device 10. Upon receiving the beacon signal, the specification unit 601 specifies the mobile object provided with the communication device that has transmitted the beacon signal on the basis of the received beacon signal, and specifies the specified mobile object as the movement means of the user. In addition, in a case where no beacon signal has been received, the specification unit 601 specifies walking as the movement means of the user.

Note that, in a case where a predetermined mobile object is specified as the movement means of the user, the specification unit 601 periodically acquires information of the inclination and the acceleration detected via the inclination sensor and the acceleration sensor provided in the specified mobile object, and an image captured by the internal camera of the mobile object.

After completion of the processing in step S400, the specification unit 601 advances the processing to step S401.

In step S401, the detection unit 602 specifies the detection sensitivity of each abnormal situation according to the movement means specified in the immediately preceding step S400 from the sensitivity table 1301.

Note that, in step S103 of the present embodiment, in a case where the movement means of the user is the predetermined mobile object, the detection unit 602 acquires a value of an index of “abnormal situation: impact” (scalar value of composite vector of accelerations of three axes detectable by acceleration sensor) on the basis of a value of acceleration detected via the acceleration sensor provided in the mobile object.

However, even in a case where the movement means of the user is the predetermined mobile object, the detection unit 602 may acquire the value of the index of “abnormal situation: impact” on the basis of the value of the acceleration detected via the acceleration sensor of the terminal device 20.

In addition, in the present embodiment, in a case where the movement means of the user is the predetermined mobile object, the detection unit 602 detects an abnormal situation on the basis of a signal detected via a sensor provided in the mobile object. In the present embodiment, in step S103, the detection unit 602 acquires a value of an index of “abnormal situation: mobile object inclination” based on the inclination value detected via the inclination sensor, and detects the mobile object inclination based on the acquired value.

In addition, in a case where the movement means of the user is the predetermined mobile object in step S103, the detection unit 602 acquires a value of an index of “abnormal situation: lying down immobile” as follows. The detection unit 602 acquires the following values on the basis of images continuously captured in time series by the internal camera of the mobile object. That is, the detection unit 602 acquires a period in which the user has not moved while taking a posture (for example, a posture in which a hand is released from the steering wheel, a posture in which the user is slumped over the steering wheel, and the like) different from a predetermined driving posture (posture of holding the steering wheel and looking forward). The detection unit 602 detects lying down immobile using the acquired period value.

In addition, in step S106 of the present embodiment, when the movement means is the predetermined mobile object and the selected abnormal situation is impact, the output control unit 603 outputs information indicating a warning about sudden braking as a warning about impact.

In addition, in the present embodiment, the detection unit 602 detects dangerous driving of the user on the basis of the image of the internal camera of the mobile object.

If the user continues a posture different from the predetermined driving posture for a predetermined period (for example, 3 seconds, 5 seconds, and the like), the detection unit 602 outputs information indicating a warning about dangerous driving to a predetermined output destination (for example, the terminal device 20, the display unit of the mobile object, the server device 10, the information processing device of the administrator, and the like). In addition, the detection unit 602 stores an image of the dangerous driving state in the auxiliary storage device 103. As a result, the server device 10 can contribute to analysis of the situation at the time of dangerous driving.

As described above, according to the configuration of the present embodiment, the server device 10 detects an abnormal situation based on a determination criterion according to the movement means of the user, so that it is possible to realize detection of an abnormal situation according to a situation where the user uses different movement means, and contribute to improvement in the accuracy of the abnormal situation.

In addition, in the present embodiment, the server device 10 sets the detection sensitivity to a predetermined value or less for an abnormal situation determined in advance for the movement means of the user as an abnormal situation in which erroneous detection is assumed. As a result, the server device 10 can reduce erroneous detection of the abnormal situation.

In addition, the server device 10 sets the detection sensitivity to a predetermined value or more for an abnormal situation determined in advance for the movement means of the user as an abnormal situation in which harm to the user is serious. As a result, the server device 10 can reduce non-detection of the abnormal situation.

In addition, in the present embodiment, if the movement means is the predetermined mobile object, the detection unit 602 acquires the value of the index of lying down immobile based on the image captured by the internal camera of the mobile object. A period during which the user does not move is more accurately obtained by the image. As a result, the detection unit 602 can detect the user lying down immobile with higher accuracy.

### Supplement

In each of the above-described embodiments, the server device 10 detects falling over, falling from a high place, impact, lying down immobile, fatigue, and high heart rate as the abnormal situation. However, the server device 10 may not detect at least a part of these abnormal situations, or may detect other abnormal situations (gas leakage, excessive reduction in heart rate, high stress, etc.). For example, the sensor 204 may include a gas sensor that detects gas. In this case, the processor 201 of the terminal device 20 detects a concentration of the gas. Then, the processor 101 may acquire the concentration of the gas from the terminal device 20 via the gas sensor, and detect gas leakage when the acquired concentration is more than or equal to a reference value. In addition, for example, the processor 201 of the terminal device 20 may acquire the concentration of the gas detected by an external device (for example, a gas detector or the like) including the gas sensor from the external device via the short-range wireless communication I/F 205, and transmit the acquired concentration of the gas to the server device 10.

In addition, for example, the processor 101 may detect high stress in a case where the heart rate of the user is more than or equal to a reference value.

In addition, in each of the above-described embodiments, as the index used for detecting the abnormal situation, the server device 10 uses the index in which a degree of the abnormal situation increases as the index increases. However, as the index used for detecting the abnormal situation, the server device 10 may use an index (for example, a reciprocal of the index in each of the above-described embodiments, the heart rate at the time of detecting an abnormal situation in which the heart rate excessively decreases, such as cardiopulmonary arrest, and the like) in which the degree of the abnormal situation becomes larger as the index is smaller. In this case, the detection unit 602 may correct the reference value in step S104 according to the sensitivity such that the smaller the sensitivity, the smaller the reference value. Then, in step S105, the detection unit 602 may detect an abnormal situation if the value of the index is less than or equal to the reference value. As a result, the server device 10 can detect the abnormal situation according to the sensitivity, even in a case of using an index in which the degree of the abnormal situation becomes larger as the index is smaller.

In addition, in each of the above-described embodiments, the work duration of the user having the terminal device 20 is used as an index used for detecting “abnormal situation: fatigue”. However, another index may be used as an index used for detecting “abnormal situation: fatigue”. For example, a stress value of the user may be used as the index used for detecting “abnormal situation: fatigue”. Here, the stress value is an index value that becomes higher as it is estimated that stress is felt. It has been found that the more stress is felt, the more the sympathetic nerve is activated.

Therefore, for example, in step S103, the detection unit 602 may estimate a degree of activation of the sympathetic nerve from the heart rate detected by the heart rate sensor included in the sensor 204 and acquire this degree as the stress value. Specifically, the detection unit 602 first measures a power spectral density in order to extract a periodic structure from time-series data of heart rate variability. The power spectral density includes a high-frequency fluctuation component (HF component) and a low-frequency component (LF component).

The detection unit 602 obtains a sum of intensities of an LF component region (from 0.05 Hz to 0.15 Hz) and an HF component region (from 0.15 Hz to 0.40 Hz) as a value of the LF component and a value of the HF component, respectively. Then, the detection unit 602 may obtain (value of LF component) / (value of HF component) as the stress value.

In a relaxed state, that is, when the parasympathetic nerve is activated, an HF component reflecting respiratory fluctuation and an LF component reflecting blood pressure fluctuation appear. On the other hand, when in a stress state, that is, when the sympathetic nerve is activated, the LF component appears while the HF component decreases. Therefore, the greater the stress, the larger the stress value.

In addition, in each of the above-described embodiments, the sensor 204 includes, in the present embodiment, the acceleration sensor that detects acceleration in three axial directions, the inclination sensor that detects inclination of the terminal device 20, the camera, the heart rate sensor that detects the heart rate of the user, the position sensor that receives the GNSS signal and detects a position, and the altimeter.

However, the sensor 204 may not include at least some of these. For example, the sensor 204 may not include the altimeter. In this case, the processor 101 may acquire altitude information from an altimeter provided in the environment in which the user performs work.

In addition, in each of the above-described embodiments, the server device 10 sets the detection sensitivity to be less than or equal to a predetermined threshold for an abnormal situation which is determined in advance for any of the work item of the work performed by the user, the work load, and the movement means of the user, and which is an abnormal situation in which erroneous detection is assumed. However, the server device 10 may have the following detection sensitivity of an abnormal situation that is determined in advance for any of the work item of the work performed by the user, the work load, and the movement means of the user, and in which erroneous detection is assumed. That is, the server device 10 may make the detection sensitivity of the abnormal situation smaller than that in a case where erroneous detection is not assumed in the abnormal situation. For example, the server device 10 may set the detection sensitivity of “falling from a high place in a work item for which erroneous detection of falling from a high place is assumed: office work” to be lower than the detection sensitivity of “falling from a high place in a work item for which erroneous detection of falling from a high place is not assumed: work at a high place”.

In addition, in each of the above-described embodiments, the output control unit 603 outputs warning information for the detected abnormal situation. The output control unit 603 may switch a display mode of the warning information according to a degree of severity of the detected abnormal situation. For example, the output control unit 603 may acquire a value of a difference obtained by subtracting the reference value from the value of the index according to the abnormal situation as a scale indicating the severity of the abnormal situation, and switch the display mode of the warning information according to the acquired scale. For example, the output control unit 603 may switch content of the warning information to be output according to whether or not the acquired scale is more than or equal to a threshold. For example, in a case where the acquired scale is more than or equal to the threshold, the output control unit 603 may output information indicating that the situation is more severe than in a case where the acquired scale is less than the threshold. In addition, in a case where the acquired scale is more than or equal to the threshold, the output control unit 603 may display warning information in a color different from that in a case where the scale is less than the threshold. In addition, in a case where the acquired scale is more than or equal to the threshold, the output control unit 603 may output a sound different from that in a case where the scale is less than the threshold as warning information. In addition, the output control unit 603 may receive a response indicating that a warning has been confirmed from an output destination of information indicating the warning. In addition, in a case where this response is not received within a predetermined period from the output of the information indicating a warning, the output control unit 603 may notify a predetermined output destination (police, fire department, etc.) of information indicating a warning about the abnormal situation. As a result, the server device 10 can improve safety of the user.

In addition, in each of the above-described embodiments, the output control unit 603 outputs information indicating a warning about an abnormal situation to the information processing device of the administrator. However, the output control unit 603 may output information indicating a warning about an abnormal situation to another output destination. For example, the output control unit 603 may output this information to the terminal devices 20 of other users present within a predetermined range centering on the user in which the abnormal situation has occurred. In addition, the output control unit 603 may output this information to the terminal device 20 included on the user in which the abnormal situation has occurred. For example, the output control unit 603 may transmit information (for example, in a case where the abnormal situation is fatigue, information indicating that it is recommended to take a break, and the like) indicating a warning about occurrence of the selected abnormal situation to the terminal device 20 of the user and cause the UI unit 206 to display this information.

In addition, the output control unit 603 may change the output destination of the information indicating a warning according to a type of the abnormal situation detected by the detection unit 602. The output control unit 603 may output warning information to the terminal device 20 of the user if the abnormal situation detected by the detection unit 602 is fatigue, and may output warning information to the terminal device 20 of another user existing around the user, the information processing device of the administrator, or the like if the abnormal situation detected by the detection unit 602 is falling from a high place. As a result, the server device 10 can present a warning about an abnormal situation to another party according to the occurrence of each abnormal situation.

In addition, in each of the embodiments described above, the output control unit 603 outputs information indicating a warning about an abnormal situation by displaying the information on the display unit. However, the output control unit 603 may output information indicating a warning about an abnormal situation in another manner. For example, the output control unit 603 may output information indicating a warning about an abnormal situation by voice via a speaker. In addition, the output control unit 603 may output information indicating a warning about an abnormal situation by vibrating a vibrator or the like or by causing a lamp such as a rotating lamp to emit light.

In addition, in each of the embodiments described above, the server device 10 detects the abnormal situation of the user based on a determination criterion according to any one of at least one of the work item and the work load of the work performed by the user and the movement means of the user. However, the server device 10 may detect an abnormal situation of the user based on a determination criterion according to both of at least one of the work item and the work load of the work performed by the user and the movement means of the user.

For example, the detection unit 602 may be configured as follows. That is, the detection unit 602 obtains the detection sensitivity of each abnormal situation as in the third embodiment, and specifies the movement means of the user as in the fourth embodiment. Then, in a case where the specified movement means is walking or a bicycle, the detection unit 602 may not update the detection sensitivity of each abnormal situation, and in a case where the specified movement means is a vehicle or a work vehicle, the detection unit 602 may update the sensitivity of a predetermined abnormal situation (for example, falling over, falling from a high place, and the like) to be less than or equal to a predetermined threshold. In addition, the detection unit 602 may specify the movement means of the user for each predetermined period, and may update the sensitivity for detecting an abnormal situation according to the specified movement means.

In addition, for example, the detection unit 602 may be configured as follows. The detection unit 602 obtains the detection sensitivity of each abnormal situation as in the fourth embodiment. Then, similarly to the second embodiment, the detection unit 602 obtains the work load of the work performed by the user. The detection unit 602 may improve the detection sensitivity of each obtained abnormal situation if the obtained work load is more than or equal to a predetermined threshold.

In addition, in the first and third embodiments described above, the specification unit 601 specifies the work item on the basis of the position of the user.

However, the specification unit 601 may specify the work item of the work performed by the user having the terminal device 20 by another method.

For example, the specification unit 601 acquires an image (for example, an image of the user, an image of an environment around the user, and the like) around the terminal device 20 captured by the camera of the terminal device 20. The specification unit 601 acquires the image around the terminal device 20 by requesting the image around the terminal device 20 from the terminal device 20. In response to the request, the processor 201 of the terminal device 20 captures the image around the terminal device 20 via the camera of the sensor 204, and transmits the captured image to the server device 10. However, the specification unit 601 may acquire an image around the terminal device 20 captured by a camera different from the camera of the terminal device 20. For example, the specification unit 601 may acquire an image captured by another camera (helmet-mounted camera, body camera, etc.) provided on the user having the terminal device 20, an image captured by a fixed camera or the like provided around the user, or the like.

The specification unit 601 may specify the work item based on the acquired image. For example, in a case where the specification unit 601 recognizes a tool (agricultural tool, tool, equipment, vehicle, or the like) used for the work of the specific work item from the image, the specification unit 601 may specify the work item of the work using the recognized tool as the work item of the work performed by the user.

In addition, for example, the specification unit 601 may acquire information of a type different from the position of the user (for example, information of a period at the time of processing, and the like), and specify the work item of the work of the user from correspondence information between the type of information and the work item. For example, in a case where the work item of the work performed by the user is determined according to the period (for example, “summer: weeding work”, “autumn: harvest work”, etc.), the specification unit 601 may specify the work item according to the processing period.

In addition, for example, in a case where a schedule of work is defined for each user, the specification unit 601 may perform as follows. That is, the specification unit 601 may acquire identification information of the user from the terminal device 20, specify the schedule of the user of the acquired identification information, and specify the work item of the work performed by the user at the time of the processing.

In addition, for example, the specification unit 601 may inquire of the terminal device 20 about the work item of the work performed by the user. In response to the inquiry, the processor 201 inquires of the user about the work item via the UI unit 206. When receiving an input (touch input, voice input, gesture input, and the like) of the work item from the user via the UI unit 206, the processor 201 transmits the input work item to the server device 10. The specification unit 601 may specify the work item received from the terminal device 20 as the work item of the work performed by the user.

In addition, for example, in a case where the processor 201 of the terminal device 20 reads code information (two-dimensional code, barcode, chameleon code, color bit, and the like) attached to a tool used for work via the camera of the sensor 204, the processor 201 may transmit information of the read code to the server device 10. The specification unit 601 may specify the work item of the work performed by the user on the basis of the information of the code. For example, the specification unit 601 may specify a work item of work using a tool according to the code.

In addition, for example, in a case where the processor 201 of the terminal device 20 performs communication with a short-range communication device (RFID chip, NFC card, etc.) attached to a tool used for work via the communication I/F 207, the processor 201 may transmit information of the tool to which the short-range communication device that has performed the communication is attached to the server device 10. The specification unit 601 may specify the work item of the work performed by the user on the basis of the information of the tool. For example, the specification unit 601 may specify a work item of work using this tool.

In addition, in the second and third embodiments described above, the specification unit 601 specifies the work load of the work performed by the user on the basis of the heart rate of the user. However, the specification unit 601 may specify the work load of the work performed by the user in another manner.

For example, the specification unit 601 specifies a work item of the work performed by the user. Here, it is assumed that correspondence information between a work item and a work load in a certain period of work is stored in advance in the auxiliary storage device 103. The specification unit 601 may specify a value obtained by multiplying the work load in a certain period according to the work item specified from the correspondence information by a period in which the user continues the work as the work load of the work performed by the user.

In addition, for example, it is assumed that correspondence information between information of a predetermined type (for example, the position, period, user identification information, and the like of the work) and the work load is stored in advance in the auxiliary storage device 103. In this case, the specification unit 601 may acquire the information of the predetermined type from the terminal device 20, and acquire the work load according to the acquired information as the work load of the work performed by the user from the correspondence information. In addition, for example, it is assumed that the schedule of the user is determined in advance, and the work load in each work is also determined in advance. In this case, the specification unit 601 may specify the work load of the work performed by the user on the basis of these items of information.

In addition, the specification unit 601 may correct the work load on the basis of weather information (temperature, humidity, illuminance, WBGT value, UV index, wind speed, etc.), environmental information (gas concentration, radioactivity, photochemical oxidant concentration, etc.), or the like. For example, if the WBGT value is more than or equal to a predetermined value, the specification unit 601 may correct the work load by multiplying the work load by a predetermined coefficient larger than 1. In addition, if the temperature is lower than or equal to a predetermined value, the specification unit 601 may correct the work load by multiplying the work load by a predetermined coefficient smaller than 1.

In addition, for example, the specification unit 601 may receive specification of the value of the work load of the work performed by the user. For example, the specification unit 601 may receive the value of the work load input by the user in the terminal device 20 from the terminal device 20.

In addition, in the above-described fourth embodiment, the communication device that transmits the beacon signal to the mobile object is provided, and when the terminal device 20 receives the beacon signal, the specification unit 601 specifies the mobile object provided with the communication device that transmits the beacon signal as the movement means of the user. However, the specification unit 601 may specify the movement means of the user in another manner.

For example, each mobile object may include a communication device different from the communication device that transmits the beacon signal. For example, each mobile object may be provided with a communication device such as an RFID tag or an NFC card. In this case, when receiving predetermined information from these communication devices via the communication I/F 207, the processor 201 of the terminal device 20 transmits the received information to the server device 10. Upon receiving this information, the specification unit 601 may specify the mobile object provided with the communication device that has transmitted this information on the basis of the received information, and specify the specified mobile object as the movement means of the user.

In addition, for example, in a case where the processor 201 of the terminal device 20 reads code information (two-dimensional code, barcode, chameleon code, color bit, and the like) attached to the mobile object via the camera of the sensor 204, the processor 201 may transmit information of the read code to the server device 10. The specification unit 601 may specify the mobile object to which the code is attached on the basis of the information of the code and specify the specified mobile object as the movement means of the user.

In addition, for example, the specification unit 601 may specify the movement means of the user on the basis of the image around the terminal device 20 captured by the camera of the terminal device 20, a camera provided on the user, an external fixed camera, an internal camera of the mobile object, or the like. In a case where the specification unit 601 recognizes at least a part (for example, external appearance, internal equipment (seat, steering wheel, etc.) ) of the mobile object from the image around the terminal device 20, the specification unit 601 may specify the mobile object as the movement means of the user.

In addition, for example, the specification unit 601 may specify the movement means of the user on the basis of a voice around the terminal device 20. For example, in a case where the specification unit 601 recognizes a predetermined sound (engine sound or the like) generated when the mobile object moves from environmental sound around the terminal device 20 recorded by a microphone of the terminal device 20, this mobile object may be specified as the movement means of the user.

In addition, for example, the specification unit 601 may specify the movement means of the user on the basis of a speed of the user. For example, the specification unit 601 may obtain a speed of the terminal device 20 from a time-series change in the position information of the terminal device 20, and specify the movement means of the user as a predetermined mobile object (for example, an automobile or a motorcycle) in a case where the obtained speed is more than or equal to a predetermined threshold (for example, 30 km/h or the like).

In addition, the above-described device, program, and method may be realized as a single device or may be realized by using a component shared by a plurality of devices, and include various aspects. In addition, the above-described device, program, and method can be changed as appropriate such that a part is software and a part is hardware. Further, the invention is also established as a recording medium of a program for controlling the device.

Of course, the recording medium of the program may be a magnetic recording medium or a semiconductor memory, and can be considered in exactly the same manner in any recording medium to be developed in the future.

### REFERENCE SIGNS LIST

1 Detection system
10 Server device
20 Terminal device
30 Network
101 Processor
102 Main storage device
103 Auxiliary storage device
104 Communication I/F
201 Processor
202 Main storage device
203 Auxiliary storage device
204 Sensor
205 Short-range wireless communication I/F
206 UI unit
207 Communication I/F
301 Reference value table
401 Sensitivity table
801 Sensitivity table
1001 Sensitivity table
1002 Sensitivity table
1201 Reference value table
1301 Sensitivity table

1. An information processing device comprising:
a specification unit that specifies at least one of an item or a load of work performed by a user; and
a detection unit that detects an abnormal situation of the user on a basis of a determination criterion according to at least one of the item or the load of work specified by the specification unit via a sensor provided on the user or around the user.

2. The information processing device according to claim 1, wherein the detection unit detects the abnormal situation on the basis of the determination criterion in which sensitivity for detecting the abnormal situation, which is determined in advance for at least one of the work item or the work load specified by the specification unit and in which occurrence of erroneous detection is assumed, is less than or equal to a threshold.

3. The information processing device according to claim 1, wherein the detection unit detects the abnormal situation on the basis of the determination criterion in which sensitivity for detecting the abnormal situation, which is determined in advance for at least one of the work item or the work load specified by the specification unit and in which occurrence of erroneous detection is assumed, is smaller than that in a case where the occurrence of erroneous detection is not assumed.

4. The information processing device according to claim 1, wherein the detection unit detects the abnormal situation on the basis of the determination criterion in which sensitivity for detecting the abnormal situation, which is determined in advance for at least one of the work item or the work load specified by the specification unit and in which serious harm to the user is assumed, is more than or equal to a threshold.

5. The information processing device according to claim 1, wherein the specification unit specifies at least one of the work item or the work load on the basis of a position of the user.

6. The information processing device according to claim 1, wherein the specification unit acquires information of a predetermined type, and specifies at least one of the item or the load of work on the basis of the acquired information and correspondence information between the information of the predetermined type and the item or the load of work.

7. The information processing device according to claim 1, further comprising an output control unit that outputs information on a warning about the abnormal situation detected by the detection unit to a predetermined output destination.

8. The information processing device according to claim 7, wherein the output control unit outputs the warning information to the output destination according to a type of the abnormal situation detected by the detection unit.

9. An information processing method executed by an information processing device, the information processing method comprising:
a specification step of specifying at least one of an item or a load of work performed by a user; and
a detection step of detecting an abnormal situation of the user on a basis of a determination criterion according to at least one of the item or the load of work specified in the specification step via a sensor provided on the user or around the user.

10. A program for causing a computer to execute:
a specification step of specifying at least one of an item or a load of work performed by a user; and
a detection step of detecting an abnormal situation of the user on a basis of a determination criterion according to at least one of the item or the load of work specified in the specification step via a sensor provided on the user or around the user.
